(19) United States
(12) Patent Application Publication
(10) Pub. No.: US 2009/0077020 A9
(43) Pub. Date: Mar. 19, 2009

(54) Systems and methods of searching databases

(76) Inventors: Hoo-min Toong, Cambridge, MA (US); Joseph G. Hadzima JR., Wellesley, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 10/624,918

(22) Filed: Jul. 22, 2003

Related U.S. Application Data
(63) Continuation-in-part of application No. 09/645,626, filed on Aug. 24, 2000, now Pat. No. 6,604,114.
Application No. 09/645,626 is a continuation of application No. 09/454,457, filed on Dec. 3, 1999, now abandoned.
(60) Provisional application No. 60/397,542, filed on Jul. 22, 2002.
(60) Provisional application No. 60/111,111, filed on Dec. 4, 1998.
(60) Provisional application No. 60/111,112, filed on Dec. 4, 1998.

(51) Int. Cl. G06F 17/30

(52) U.S. Cl. 707/3

(57) ABSTRACT

Systems and methods for searching databases are described herein. In one embodiment, a method for searching a database can include identifying a first set of one or more data elements that are referenced by a starting data element, identifying a second set of one or more data elements that reference one or more of the data elements of the first set, and graphically displaying the data elements of the first and second sets and the relationships therebetween. In one embodiment, the systems and methods can be used to identify prior art patent publications for a starting patent publication.

### REFERENCE TO RELATED APPLICATIONS

This application claims priority to U.S. Patent Application Serial No. 60/397,542 filed on Jul. 22, 2002.

This application is related to U.S. patent application Ser. No. (Attorney Docket No. TCK-001.03 (21945-103)) filed on (even date herewith), which application is a continuation of U.S. patent application Ser. No. 09/645,626 filed on Aug. 24, 2000, which application is a continuation of U.S. patent application Ser. No. 09/454,457 filed on Dec. 3, 1999, which application claims priority to U.S. Patent Application Serial Nos. 60/111,111 and 60/111,112 both filed on Dec. 4, 1998.

All of these applications are incorporated explicitly by reference herein in their entireties.

### BACKGROUND

Many databases can be accessed using the Internet. For example, the U.S. Patent and Trademark Office, the European Patent Office, and other governmental and non-governmental organizations maintain databases of patent publications. As used herein, a patent publication can include an issued patent and a patent application (including published and unpublished patent applications).

Some of these databases can include interrelated data elements. For example, databases of patent publications can include patents that reference other patents. As used herein, two data elements can be interrelated if at least one of the data elements references the other data element.

Relationships between interrelated data elements can be understood in terms of one-dimensional constructs. For example, relationships between a patent that references other patents can be understood in terms of one-dimensional lists of referenced patents. Using one-dimensional constructs to search databases for interrelated data elements lacks efficiency.

### SUMMARY

Systems and methods of searching databases are described herein.

In one embodiment, a method of searching a database of data elements can include identifying a first set of data elements that are referenced by a starting data element, identifying a second set of data elements that reference the first set of data elements, and generate data based on the data elements of the first and second sets and their relationships.

In one aspect, identifying a first set of data elements can include determining whether the starting data element references other data elements.

In one aspect, identifying a second set of data elements can include determining whether the database includes data elements that reference the data elements of the first set.

In one aspect, the starting data element can be associated with a starting time, identifying the first set of data elements can include identifying data elements that are referenced by the starting data element and that are associated with first times earlier than the starting time, and identifying the second set of data elements can include identifying data elements that reference the data elements of the first set and that are associated with second times later than the first times and earlier than the starting time.

In one embodiment, the method can further include providing the generated data to one or more of a user and a display.

In one embodiment, the method can further include graphically displaying the data elements of the first and second sets and their relationships. The data elements can be represented by geometric shapes and the relationships can be represented by lines between the geometric shapes. The geometric shapes and the lines can be displayed at locations that reduce overlaps between the geometric shapes and crossings between the lines.

A method of searching a database to identify prior art publications for a starting patent publication is described herein. In one embodiment, the method can include identifying a first set of publications that are cited by a starting patent publication, identifying a second set of publications that cite the publications of the first set, and generating data based on the publications of the first and second sets and the citation relationships between the publications.

In one aspect, the publications can include patent publications and non-patent publications. The patent publications can include issued patents and patent applications, such as published patent applications and unpublished patent applications.

In one embodiment, the method can further include identifying one or more candidate patent publications for invalidating prior art for the starting patent publication. The candidate patent publications for invalidating prior art can include patent publications in the second set that do not cite the starting patent publication, that are not cited by the starting patent publication, and that are associated with filing dates earlier than the starting patent publication.

In one embodiment, the method can further include identifying one or more candidate patent publications for licensing opportunities. The candidate patent publications for licensing opportunities can include patent publications that are associated with a first assignee and that are cited by patent publications associated with different second assignee(s).

In one embodiment, the method can further include identifying one or more candidate patent publications for seminal prior art. The candidate patent publications for seminal prior art can include patent publications that cite a first number of patent publications and that are cited by a second number of patent publications, wherein the second number is greater than the first number.

In one embodiment, the method can further include identifying one or more co-citing patent publications. The co-citing patent publications can include patent publications of the second set that are associated with filing dates later than the filing date of the starting patent publication and/or publication dates later than the filing date of the starting patent publication.

In one embodiment, the method can further include determining a patent prosecution strategy based on the co-citing patent publications. The patent prosecution strategy can include filing one or more claims in a pending application, filing one or more continuing applications of a parent application, declaring one or more interferences, and disclosing the co-citing patent publications to a patent-granting office.

A processor program for searching a database to identify prior art publications for a starting patent publication is described herein. The processor program can be stored on a processor readable medium. In one embodiment, the processor program can include instructions operable to cause a processor to identify a first set of one or more publications that are cited by the starting patent publication, identify a second set publications that cite the publications of the first set, and generate data based on the publications of the first and second sets and the citation relationships between the publications.

These and other features of the systems and methods described herein can be more fully understood by referring to the following detailed description and accompanying drawings.

### BRIEF DESCRIPTION OF THE DRAWINGS

FIGS. 1A and 1B schematically illustrate an exemplary system for searching a database.

FIG. 2 illustrates an exemplary keyword grid for systems according to FIGS. 1A and 1B.

FIGS. 3 and 4 illustrate exemplary graphical displays of data elements for systems according to FIGS. 1A and 1B.

### DETAILED DESCRIPTION

Illustrative embodiments will now be described to provide an overall understanding of the systems and methods described herein. One or more examples of the illustrative embodiments are shown in the drawings. Those of ordinary skill in the art will understand that the systems and methods described herein can be adapted and modified to provide devices, methods, schemes, and systems for other applications, and that other additions and modifications can be made to the systems and methods described herein without departing from the scope of the present disclosure. For example, aspects, components, features, and/or modules of the illustrative embodiments can be combined, separated, interchanged, and/or rearranged to generate other embodiments. Such modifications and variations are intended to be included within the scope of the present disclosure.

The disclosed systems and methods relate to searching database(s) for interrelated data elements. The disclosed systems and methods can receive search data from a user, such as a starting data element, can identify data element(s) in the database(s) that are related to the starting data element, and can display the data element(s) and their relationships to the starting data element in image(s) having two or more dimensions.

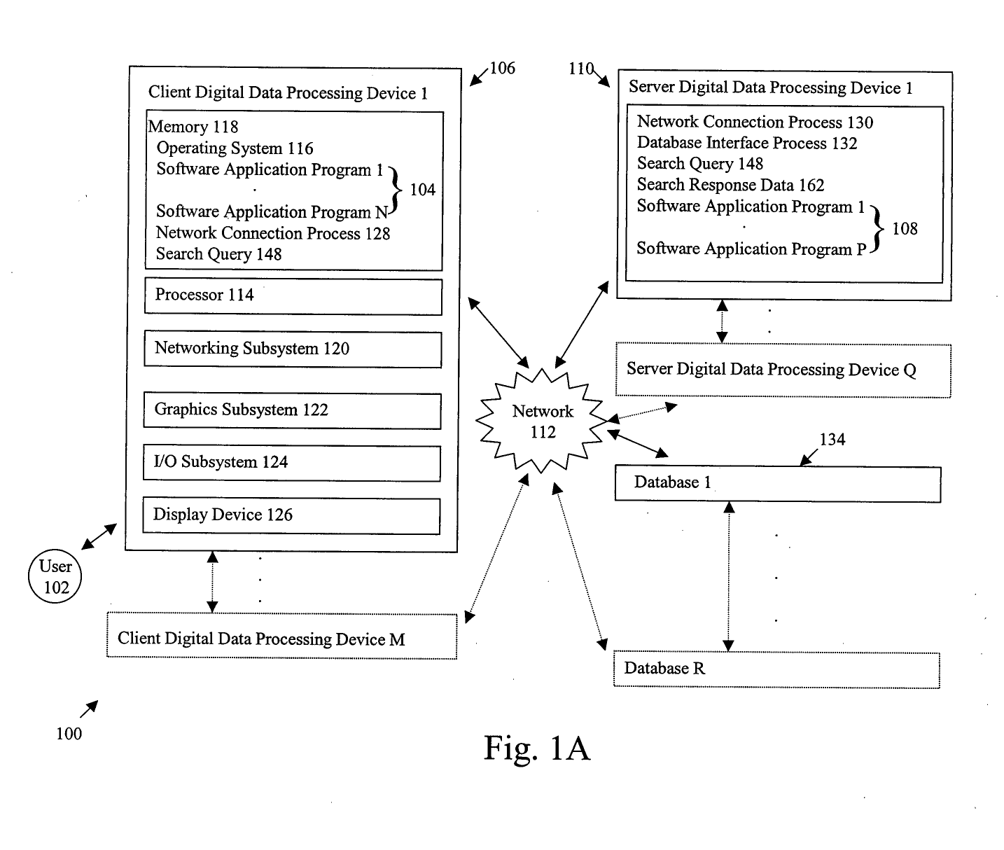

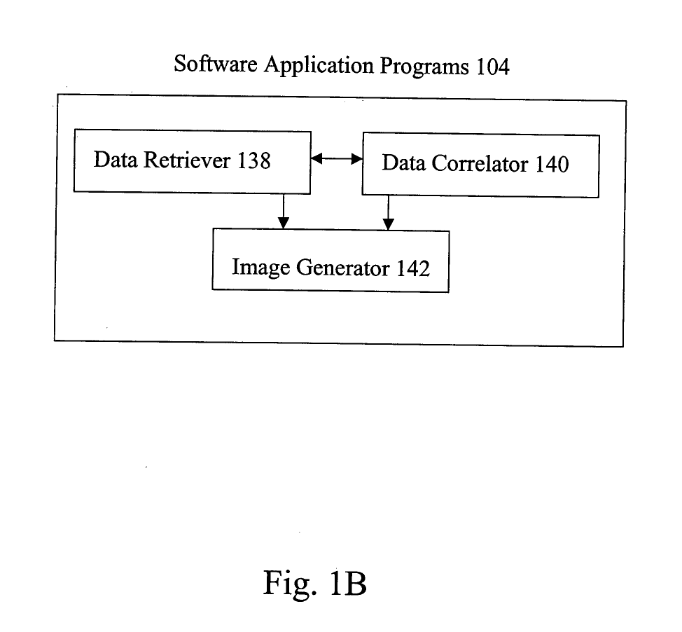

FIG. 1A schematically illustrates an exemplary system for searching a database. As shown in FIG. 1A, the illustrated system 100 can include one or more client digital data processing devices 106 (“client”), one or more server digital data processing devices 110 (“server”), and one or more databases 134. The client 106, the server 110, and the database 134 can communicate using one or more data communications networks 112. The features in a digital data processing device are shown as residing in the client 106. Those of ordinary skill in the art will understand that one or more of the features of the client 106 can be present in the server 110.

As shown in the system 100 of FIG. 1A, a user 102 desiring to search the database 134 can execute one or more software application programs 104 (such as, for example, an Internet browser and/or another type of application program capable of providing an interface to a database search application program) residing on the client 106 to generate data messages that are routed to, and/or receive data messages generated by, one or more software application programs 108 (e.g. search application programs) residing on the server 110 via the data communications network 112. A data message can comprise one or more data packets, and the data packets can comprise control information (e.g. addresses of the clients and the servers 106, 110, names/identifiers of the software application programs 104, 108, etc.) and payload data (e.g. data relevant to a search, such as a search query 148 and search response data 162).

The software application programs 104 can comprise one or more software processes (e.g., a calculation process/engine) executing within one or more memories 118 of the client 106. Similarly, the software application programs 108 can comprise one or more software processes executing within one or more memories of the server 110. The software application programs 104, 108 can be provided using a combination of built-in features of one or more commercially available software application programs and/or in combination with one or more custom-designed software modules.

Although the features and/or operations of the software application programs 104, 108 are described herein as being executed in a distributed fashion (e.g., operations performed on the networked client and servers 106, 110), those of ordinary skill in the art will understand that at least some of the operations of the software application programs 104, 108 can be executed within one or more digital data processing devices that can be connected by a desired digital data path (e.g. point-to-point, networked, data bus, etc.).

The digital data processing device 106, 110 can be a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data. A processor 114 can refer to the logic circuitry that responds to and processes instructions that drive digital data processing devices and can include, without limitation, a central processing unit, an arithmetic logic unit, an application specific integrated circuit, a task engine, and/or combinations, arrangements, or multiples thereof.

The instructions executed by a processor 114 can represent, at a low level, a sequence of “0's” and “1's” that describe one or more physical operations of a digital data processing device. These instructions can be pre-loaded into a programmable memory (e.g. an electrically erasable programmable read-only memory (EEPROM)) that is accessible to the processor 114 and/or can be dynamically loaded into/from one or more volatile (e.g. a random-access memory (RAM), a cache, etc.) and/or non-volatile (e.g. a hard drive, etc.) memory elements communicatively coupled to the processor 114. The instructions can, for example, correspond to the initialization of hardware within the digital data processing devices 106, 110, an operating system 116 that enables the hardware elements to communicate under software control and enables other computer programs to communicate, and/or software application programs 104, 108 that are designed to perform operations for other computer programs, such as operations relating to searching the database 134. The operating system 116 can support single-threading and/or multi-threading, where a thread refers to an independent stream of execution running in a multi-tasking environment. A single-threaded system can be capable of executing one thread at a time, while a multi-threaded system can be capable of supporting multiple concurrently executing threads and can perform multiple tasks simultaneously.

A local user 102 can interact with the client 106 by, for example, viewing a command line, using a graphical and/or other user interface, and entering commands via an input device, such as a mouse, a keyboard, a touch sensitive screen, a track ball, a keypad, etc. The user interface can be generated by a graphics subsystem 122 of the client 106, which renders the interface into an on- or off-screen surface (e.g. on a display device 126 and/or in a video memory). Inputs from the user 102 can be received via an input/output (I/O) subsystem 124 and routed to a processor 114 via an internal bus (e.g. system bus) for execution under the control of the operating system 116.

Similarly, a remote user (not shown) can interact with the digital data processing devices 106, 110 over the data communications network 112. The inputs from the remote user can be received and processed in whole or in part by a remote digital data processing device collocated with the remote user. Alternatively and/or in combination, the inputs can be transmitted back to and processed by the local client 106 or to another digital data processing device via one or more networks using, for example, thin client technology. The user interface of the local client 106 can also be reproduced, in whole or in part, at the remote digital data processing device collocated with the remote user by transmitting graphics information to the remote device and instructing the graphics subsystem of the remote device to render and display at least part of the interface to the remote user. Network communications between two or more digital data processing devices can comprise a networking subsystem 120 (e.g. a network interface card) to establish the communications link between the devices. The communications link interconnecting the digital data processing devices can comprise elements of a data communications network, a point to point connection, a bus, and/or another type of digital data path capable of conveying processor-readable data.

In one illustrative operation, the processor 114 of the client 106 can execute instructions associated with the software application program 104 (comprising, for example, runtime instructions specified, at least partially, by the local user 102 and/or by another software application program, such as a batch-type program) that can instruct the processor 114 to at least partially control the operation of the graphics subsystem 122 in rendering and displaying a graphical user interface (comprising, for example, one or more menus, windows, and/or other visual objects) on the display device 126.

The data communications network 112 can comprise a series of network nodes (e.g. the client and the servers 106, 110) that can be interconnected by network devices and wired and/or wireless communication lines (e.g. public carrier lines, private lines, satellite lines, etc.) that enable the network nodes to communicate. The transfer of data (e.g. messages) between network nodes can be facilitated by network devices, such as routers, switches, multiplexers, bridges, gateways, etc., that can manipulate and/or route data from an originating node to a server node regardless of dissimilarities in the network topology (e.g. bus, star, token ring), spatial distance (local, metropolitan, wide area network), transmission technology (e.g. transfer control protocol/internet protocol (TCP/IP), Systems Network Architecture), data type (e.g. data, voice, video, multimedia), nature of connection (e.g. switched, non-switched, dial-up, dedicated, or virtual), and/or physical link (e.g. optical fiber, coaxial cable, twisted pair, wireless, etc.) between the originating and server network nodes.

FIG. 1A shows processes 128, 130, 132. A process can refer to the execution of instructions that interact with operating parameters, message data/parameters, network connection parameters/data, variables, constants, software libraries, and/or other elements within an execution environment in a memory of a digital data processing device that causes a processor to control the operations of the digital data processing device in accordance with the desired features and/or operations of an operating system, a software application program, and/or another type of generic or specific-purpose application program (or subparts thereof). For example, a network connection process 128, 130 can refer to a set of instructions and/or other elements that enable the digital data processing devices 106, 110, respectively, to establish a communication link and communicate with other digital data processing devices during one or more sessions. A session refers to a series of transactions communicated between two network nodes during the span of a single network connection, where the session begins when the network connection is established and terminates when the connection is ended. A database interface process 132 can refer to a set of instructions and other elements that enable the server 110 to access the database 134 and/or other types of data repositories to obtain access to, for example, data elements, such as patent publications and non-patent publications. The accessed information can be provided to the software application program 108 for further processing and manipulation. Those of ordinary skill in the art will understand that the illustrated processes and/or their features can be combined into one or more processes. The illustrated processes 128, 130, 132 can also be provided using a combination of built-in features of one or more commercially-available software application programs and/or in combination with one or more custom-designed software modules.

The databases 134 can be stored on a non-volatile storage medium or a device known to those of ordinary skill in the art (e.g., compact disk (CD), digital video disk (DVD), magnetic disk, internal hard drive, external hard drive, random access memory (RAM), redundant array of independent disks (RAID), or removable memory device). As shown in FIG. 1A, the databases 134 can be located remotely from the client 106. In some embodiments, the databases 134 can be located locally to the client 106 and/or can be integrated into the client 106. The databases 134 can include distributed databases. The databases 134 can include databases of patent publications and/or non-patent publications. As used herein, patent publications can include issued patents and pending patent applications (including published and unpublished patent applications), and non-patent publications can include publications other than patent publications. As used herein, a non-patent publication can refer to a publicly disclosed data element, as the term publicly disclosed is understood by those of ordinary skill in the art of prevailing patent law (e.g. U.S., or other jurisdictional, patent law). The databases 134 can include different types of data content and/or different formats for stored data content.

FIG. 1B shows an exemplary set of software application programs 104 residing on client 106. As shown in FIG. 1B, the software application programs 104 can include a data retriever 138, a data correlator 140, and an image generator 142, all of which can intercommunicate. Those of ordinary skill in the art will understand that the illustrated software application programs 138, 140, 142 and/or their features can be combined into one or more programs.

The data retriever 138 shown in FIG. 1B can generate a search query 148 shown in FIG. 1A for identifying data elements in the database 134. The data retriever 138 can generate the search query 148 based on search data provided by a user 102. For example, the user 102 can provide search data to the client 106 via I/O subsystem 124. The software application program 104 executing within the memory 118 of the client 106 can detect the search data via an indication from the I/O subsystem 124 and can provide the search data to the data retriever 138.

The search data can include alphanumeric data. In one embodiment, the search data can include data relevant to searching a database of patent publications and/or non-patent publications. For example, in one such embodiment, the search data can include one or more of an assignee name, an inventor name, a patent application filing date, a patent issue date, a technology classification and/or sub-classification, and an identifying number (e.g. a patent application serial number, a published patent application publication number, or a patent issue number).

In one embodiment, the data retriever 138 can generate the search query 148 by parsing or otherwise processing the search data provided by the user to identify keywords. The data retriever 138 can include a keyword parser, such as an expanded macro function, a weighting scheme, and/or other processing schemes known to those of ordinary skill in the art. The data retriever 138 can generate a search query that includes the keywords based on schemes known to those of ordinary skill in the art.

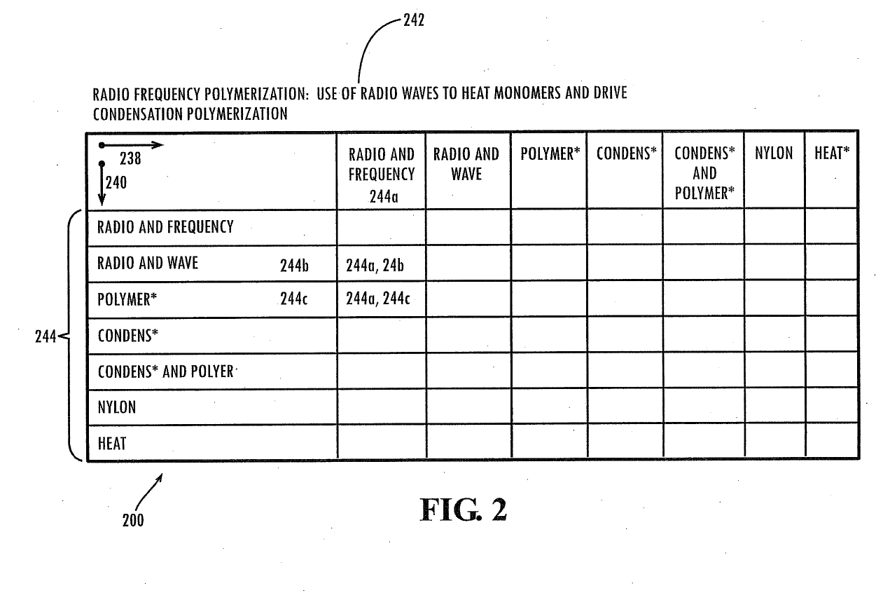

FIG. 2 shows an exemplary keyword grid 200 that can be used by the data retriever 138 to generate different search queries using the same search data. As shown in FIG. 2, in one embodiment, the keyword grid 200 can store the keywords 244 identified in search data 242 along horizontal and vertical axes 238, 240. The keywords 244 can include wildcard elements represented in FIG. 2 by asterisks. The data retriever 138 can generate different search queries 148 based on pairs of keywords from the horizontal and vertical axes 238, 240. For example, as shown in FIG. 2, the data retriever 138 can generate a first search query 148 based on a first pair of keywords from the horizontal and vertical axes (e.g. 244a, 244b) and a second search query 148 based on a second pair of keywords from the horizontal and vertical axes (e.g. 244a, 244c). Since the first and second search queries 148 are based on keywords from the same search data 242, they are not independent. As such, data elements retrieved from the database 134 for the first and second search queries 148 can include repetitions of the same data elements. In one embodiment, the software application program 108, the software application program 104, and/or another program or process on the client 106 and/or the server 110 can coalesce the data elements retrieved from the database 134 to remove duplicative data elements.

The data retriever 138 can search the databases 134 using the search query 148. With reference to the FIG. 1A embodiment, the search query 148 generated by the data retriever 138 can be maintained in the memory 118 of the client 106 prior to transmission to the server 110 via the network 112. The software application program 104 can instruct the network connection process 128 of the client 106 to transmit the search query 148 to the software application program 108 executing on the server 110 by, for example, encoding, encrypting, and/or compressing the search query 148 into a stream of data packets that can be transmitted between the networking subsystems 120 of the digital data processing devices 106, 110. The network connection process 130 executing on the server 110 can receive, decompress, decrypt, and/or decode the information contained in the data packets and can store such elements in a memory accessible to the software application program 108. The software application program 108 can access the search query 148 to obtain information that can enable the software application program 108 to issue a query to the database 134 to access the stored data elements. The software application program 108 can instruct the database interface process 132 to access the database 134 using the search query 148 based on schemes known to those of ordinary skill in the art.

The software application program 108 can generate search response data 162 to report the results of the search query 148 to the client 106 and the user 102. In some embodiments, the search response data 162 can include data elements retrieved from and/or otherwise identified in the databases 134 based on the search query 148. Alternatively and/or in combination, the search response data 162 can include one or more references to the identified elements. For example, the references can include one or more of: citations, hypertext markup language (HTML) links, pointers, and other types of links known to those of ordinary skill in the art. Based on the search response data 162, the software application program 108 can form a code page (e.g. one or more modules of software code) that can be compiled into an executable, function library, and/or a component containing executable code that can be initiated or otherwise activated by the executable or another executing controller (e.g. an operating system service). The code can be executed to form the search response data 162. Once the code is executed to form the search response data 162, the software application program 108 can instruct the network connection process 130 to transmit the search response data 162 to the software application program 104 of the client 106. Upon receiving the transmitted search response data 162, the software application program 104 can manipulate and/or provide the search response data 162 to the user 102 as described herein.

The data correlator 140 can determine relationships between data elements. In one embodiment, the data correlator 140 can determine relationships between data elements based on references associated with the data elements. The references can be associated with the content of the data elements. For example, the references can include citations, hypertext markup language (HTML) links, pointers, and other types of links known to those of ordinary skill in the art in the content of the data elements. (For example, as will be understood by those of ordinary skill in the art, one or more of the title page(s) of a U.S. patent publication, such as an issued patent or a published patent application, can include citations to other patent publications and non-patent publications.) Alternatively and/or in combination, the data correlator 140 can determine relationships between data elements based on one or more of: references based on contextual data in a data element that can be developed into an association with another data element, references based on intervening sources (e.g. look-up tables, such as a dictionary and a thesaurus), references based on associations of content in data elements, and references based on an infer-trends process that, as described herein, can include information based on a graphical representation of the retrieved data elements and their interrelationships. The data correlator 140 can determine relationships between data elements iteratively. For example, the data correlator 140 can determined relationships based on iterative communication with the data retriever 138, as described herein. The data correlator 140 can determine whether a first data element is associated with a reference to a second data element based on schemes known to those of ordinary skill in the art.

In one embodiment, the data correlator 140 (and/or one or more of the software application programs 104, 108) can include database translators to determine relationships between data elements retrieved from or otherwise identified in different databases, such as databases having different types of data content and/or different formats for data content. The database translators can be configured to identify similar information in different data formats based on schemes known by those of ordinary skill in the art.

As previously described, the search response data 162 can include one or more data elements retrieved or otherwise identified in the databases 134 (and/or one or more references to the one or more identified data elements) based on the search query 148. These data elements can be referred to as a first set of data elements 162. In one embodiment, the data correlator 140 can identify in the database 134 a second set of data elements that reference one or more of the data elements of the first set 162. The data correlator 140 can identify the second set by following a deductive approach. For example, in one such embodiment, the data correlator 140 can determine whether the data elements of the first set 162 are associated with references to (e.g. include links to) data elements in the database 134. Alternatively and/or in combination, the data correlator 140 can follow an inductive approach. For example, in one such embodiment, the data correlator 140 can iteratively determine whether the database 134 includes data elements that are associated with references to (e.g. that include links to) the data elements of the first set 162. In such an embodiment, the data correlator 140 can communicate with the data retriever 138 to generate search queries 148 for the database 134 based on the data elements of the first set 162. For example, the data correlator 140 can communicate with the data retriever 138 to generate search queries 148 that include identifying data associated with the data elements of the first set 162 (for a patent publication, such identifying data can include, for example, a title and an identifying number (e.g. a patent application serial number, a published patent application publication number, or a patent issue number)).

Illustrative database searches that can be performed using the disclosed systems and methods will now be described. Those of ordinary skill in the art will understand that the illustrative searches are to be interpreted in an exemplary manner and that searches different than those described herein can be used within the scope of the present disclosure. For example, aspects, components, features, and/or modules of the searches described herein can be combined, separated, interchanged, and/or rearranged to generate other searches.

In one illustrative search, data elements having a particular time relationship to a starting data element can be identified. In one such illustrative search, a starting data element associated with a starting time (e.g. a date of publication) can be provided. Based on the starting data element, the data retriever 138 can generate a search query 148 to identify data elements in the database 134 that are referenced by the starting data element and that are associated with times earlier than the starting time. The identified data elements can be referred to as the first set and can be associated with first times. Based on the first set, the data retriever 138 and the data correlator 140 can identify data elements in the database that reference one or more of the data elements of the first set and that are associated with second times that are later than the first times and earlier than the starting time. As will be understood by those of ordinary skill in the art, the illustrative search can be contracted, expanded, and/or otherwise modified to include one or more generations of interrelated data elements. For example, the illustrative search can be expanded to include one or more later generations (e.g. expanded in the forward time direction to find data elements that reference a starting data element) and/or one or more earlier generations (e.g. expanded in the backward time direction to find data elements referenced by a starting data element).

For example, the previously described illustrative search can be used to identify candidate publications for prior art to a starting patent publication. As used herein, the term publication can refer to one or more of a patent publication and a non-patent publication, and the term prior art can refer to prior art as understood by those of ordinary skill in the art of prevailing patent law (e.g. U.S., or other jurisdictional, patent law). In a prior art search, a starting patent publication (e.g. an alleged infringed patent) having a starting time (e.g. a patent application filing date) can be provided. Based on the starting patent publication, the data retriever 138 can generate a search query 148 to identify publications in the database 134 that are cited by the starting patent publication. The identified publications can be referred to as the first set. Based on the first set, the data retriever 138 and/or the data correlator 140 can identify publications in the database that cite one or more of the publications of the first set and that are associated with filing dates (for patent publications) or publication dates (for patent publications and non-patent publications) earlier than the filing date of the starting patent publication. These publications can be referred to as candidates for prior art.

As will be understood by those of ordinary skill in the art, the candidates for prior art can have different degrees of relevance to the starting patent publication. In one embodiment, the candidates for prior art can be used to identify candidates for invalidating prior art. Candidate publications for invalidating prior art can include those candidates for prior art that do not cite the starting patent publication and that are not cited by the starting patent publication. In some embodiments, the candidate publications for invalidating prior art can be differentiated based on the number of references they include to the publications of the first set. In one embodiment, candidates that include references to more of the publications of the first set can be considered to be stronger candidates for invalidating prior art than candidates that include references to less of the publications of the first set. In one such embodiment, a user can provide a threshold number of references to the publications of the first set, with candidates having numbers of references greater than or equal to the threshold being considered strong candidates.

As shown in FIG. 1B, the data retriever 138 and the data correlator 140 can communicate with the image generator 142. In one embodiment, the data retriever 138 and the data correlator 140 can provide the image generator 142 with the data elements retrieved from or otherwise identified in the database 134 and the relationships between those data elements. For example, in one such embodiment, with continuing reference to the previously described illustrative search, the data retriever 138 and the data correlator 140 can provide the image generator 142 with the starting data element, the first and second sets of data elements, and their interrelationships. As described herein, the image generator 142 can generate interconnected graphs based on the data elements and their interrelationships. These graphs can be referred to as webs.

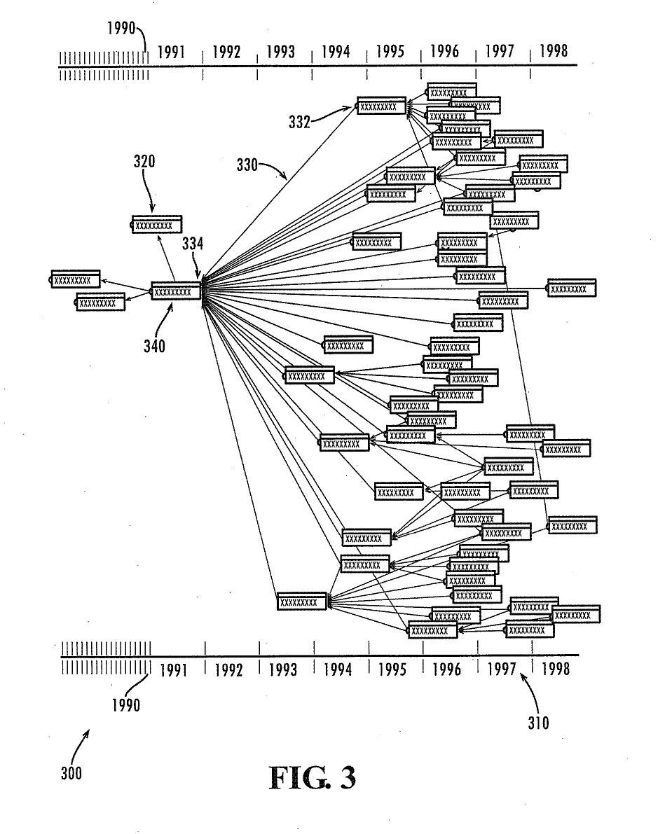

FIG. 3 illustrates an exemplary web of interrelated data elements (e.g. issued patents). As shown in FIG. 3, a web 300 can be displayed in two dimensions having a time axis 310 and can include one or more geometric shapes 320 and one or more lines 330 between the geometric shapes 320. In the shown embodiment, the geometric shapes 320 can represent the data elements and the lines 330 can represent the relationships between the data elements. The lines 330 can include vectors having starts 332 (denoted in FIG. 3 by open circles) and stops 334 (denoted in FIG. 3 by arrowheads), in which the starts 332 can denote referencing patents and the stops 334 can denote referenced patents. The geometric shapes 320 can include information identifying the data elements (denoted XXX in FIG. 3). In one embodiment, in response to a selection of a geometric shape (by, for example, a user 102), the image generator 142 can graphically display the contents of the data element. As shown in FIG. 3, the time axis 310 can include demarcations for selected periods of time, e.g. years, months, weeks, days, etc.

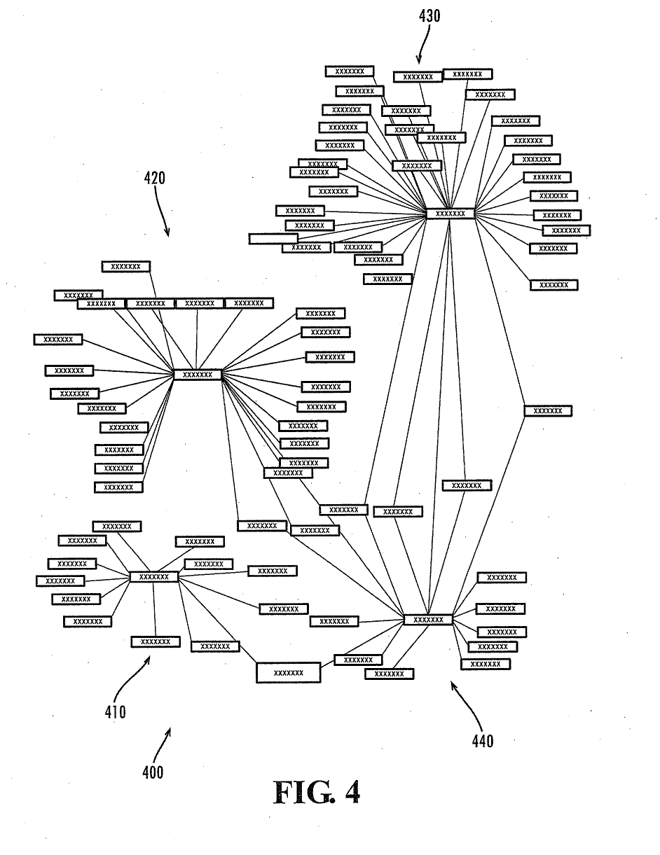

FIG. 4 illustrates an interconnected web 400 of data elements. As shown in FIG. 4, webs 410, 420, 430, 440 similar to the web 300 shown in FIG. 3 can be interconnected to form web 400.

In some embodiments, visual patterns of data elements in the webs can be used to infer information about the data elements. For example, based on the visual patterns in the webs, candidate publications for invalidating prior art, candidate patent publications for licensing opportunities, and candidate patent publications for seminal prior art can be identified. Candidate patent publications for invalidating prior art can be identified in the webs based on schemes previously described herein. Candidate patent publications for licensing opportunities can be identified in the webs by locating patent publications that are associated with a first assignee and that are cited by patent publication(s) associated with different assignee(s). Candidate patent publications for seminal prior art can be identified in the webs based on locating patent publications that cite a first number of patent publications and that are cited by a second number of patent publications, in which the second number is greater than the first number. For example, in one embodiment, FIG. 3 shows a web of interrelated patents that converges at data element 340. Such a convergence can imply a candidate publication for seminal prior art and/or a candidate publication for licensing opportunities. As will be understood by those of ordinary skill in the art, the disclosed systems and methods are not limited to the visual schemes described herein and can use other visual and/or non-visual schemes to infer information about the data elements.

Alternatively and/or in combination, the webs described herein can be used to identify statistical trends as well as the previously described graphical trends. In one such embodiment, statistics based on features of a web can be calculated to facilitate understanding of the interrelationships in the web. Such statistics can include one or more of: summary statistics (e.g. based on a web, identifying those assignees associated with the greatest numbers of assigned patents), comparative statistics (e.g. based on a web, identifying relative strengths of patent portfolios held by different assignees), statistics based on time, and statistics based on criteria such as the frequency at which data elements appear or the interrelationships between data elements.

The image generator 142 can generate the webs 300, 400 by processing the data elements and their interrelationships functionally and/or mathematically. Functionally, the image generator can use geometric shapes (e.g. rectangles, circles, etc.), colors, line types (e.g. straight and/or curved), line styles (e.g. solid, dotted, etc.), axis types (linear and/or non-linear), and other graphical features to present the webs 300, 400. Mathematically, the image generator 142 can determine locations at which to place the geometric shapes 320 and the lines 330 in the webs 300 based on one or more models that can control graphical features, such as overlaps between shapes and lines, spacings between shapes and lines, and connections between shapes and lines.

The image generator 142 can generate webs based on the schemes described herein. In the following description, a node can represent a data element and an edge can represent a link (e.g. a connection, a reference, etc.) between data elements. The link can include one-way links and two-way links. The nodes can include different shapes and/or sizes. As described herein, in one embodiment, the image generator 142 can determine locations in a web at which to display the nodes and the edges to reduce overlapping between the nodes and/or the edges. In embodiments including two-dimensional webs, feature(s) of a node can be used to determine one or both of the coordinates at which to display the node. For example, in a web including issued patents, the issue dates of the patents can be associated with a horizontal or x-axis of the web (such as the time axis 310 of the web 300 shown in FIG. 3). In embodiments including three-dimensional webs, dynamic presentation schemes known to those of ordinary skill in the art can be used to determine the three coordinates at which to display the nodes in the webs. In some embodiments, crossings of edges can be allowed. For example, crossings can be allowed when features of the nodes are considered to be more important to determining the locations of the nodes than reducing crossings. As will be understood by those of ordinary skill in the art, the edges in a web can occupy more of the presentation area of the web than the nodes. In some embodiments, therefore, the length of the edges and the overlaps between nodes can be reduced to generate more visually appealing (e.g. less “cluttered”) webs.

An illustrative scheme for determining locations in a web at which to display nodes and edges will now be described. Those of ordinary skill in the art will understand that the illustrative scheme is to be interpreted in an exemplary manner and that schemes different than those described herein can be used within the scope of the present disclosure.

The illustrative scheme can be based on a hierarchical structure of undirected graphs. Definitions of terms used in the following description are provided for the reference of the reader. Let G=(G, E) represent a connected graph G (i.e. a web) having edges E and let L=(L, F) represent a sub-graph L in which L⊂G and F⊂E. A sub-graph L can be referred to as a cycle if, for any starting node in L, each edge and each node in L can be traversed once and only once to return to the starting node. A sub-graph L that includes a single node can be referred to as a trivial cycle because the sub-graph L does not include any edges. Nodes in G can be referred to as tree nodes and cycle nodes. Tree nodes are those nodes that do not form a part of a non-trivial cycle, and cycle nodes are all other nodes. Similarly, tree edges are edges that do not form part of a non-trivial cycle, and cycle edges are all other edges. Generally, a connected graph can be a tree if and only if the connected graph does not include cycle edges. A pure cycle graph (PCG) is a graph that includes neither tree nodes nor tree edges. A sub-graph that is a PCG can be referred to as a PCG-sub-graph (PCSG). A maximal PCG-sub-graph (MPCSG) is a PCSG to which nodes and/or edges cannot be added and still maintain the PCSG character.

As will be understood by those of ordinary skill in the art, an undirected graph can be represented as a tree of PCSGs of trees (tree-PCSG-tree hierarchy). Generally, to determine the locations at which to display the nodes and the edges in the undirected graph, the non-tree nodes in G can be aggregated one by one until all non-tree nodes have been aggregated and each MPSG can be aggregated into a single node to generate a top level tree T. Using such a hierarchy, a divide-and-conquer type of tree layout algorithm can be developed and applied to both the top level tree T and other lower-level trees t (i.e. sub-trees t) that emanate from the top level tree T, and a PCSG layout algorithm can be developed and applied to each PCSG in the tree T, as will be understood by those of ordinary skill in the art.

The schemes previously described herein can be used by the image generator 142 to generate the webs 300, 400 shown in FIGS. 3 and 4, respectively. In some embodiments, the sub-trees t can be laid out before the top-level tree T so that the size of the sub-trees can be used to determine the location of the top-level tree T. Selective arrangement of the sub-trees t can generate more visually appealing (i.e. less “cluttered”) webs. For example, in one such embodiment, one or more of the sub-trees t can be arranged based on one or more spatial extents of their bounding boxes. The sub-trees t can be laid out symmetrically with respect to the top level tree T and gaps between the sub-trees t can be reduced to use space efficiently. As described herein, the locations of the bounding boxes of the sub-trees t can be determined recursively.

In some embodiments, the total length of the edges in a sub-tree t can be computed as a performance function that seeks to reduce a number of overlaps between shapes and crossings between lines. The performance function can be solved as an optimization over Sₙ, which represents a permutation group of n elements. An artificial constraint of sequential ordering of the nodes in a PCG can be used to simplify the optimization. In such an optimization, each node in a PCG can be associated with an amount of space determined by the spatial extent of its bounding box, which spatial extent can be calculated during the layout of the sub-tree t to which the PCG is connected. Sequential ordering of nodes having non-overlapping bounding boxes can be used to generate layouts in which overlaps between the nodes in G are reduced. Generally, the ordering of nodes that minimizes the total length of the edges can be used to determine the layout of a sub-tree t. As will be understood by those of ordinary skill in the art, exhaustive search over Sₙ is not generally possible (except for small n) because the size of Sₙ is n!. As such, in some embodiments, the concept of steepest decent known to those of ordinary skill in the art of optimization of continuous variables can be used. The search can be performed in a local neighborhood of an element n in Sₙ, and the best n can be chosen as the next state. The search can be repeated until a local minimum is found.

The disclosed systems and methods can be used to facilitate numerous business objectives, such as the business objectives previously described herein. Other illustrative business objectives that can be facilitated using the disclosed systems and methods will now be described. Those of ordinary skill in the art will understand that the illustrative business objectives are to be interpreted in an exemplary manner and that business objectives different than those described herein can be facilitated within the scope of the present disclosure.

In one embodiment, the disclosed systems and methods can be used to identify a patent portfolio. A patent portfolio can include two or more patent publications that have the same assignees, the same technological classifications and/or sub-classifications, and references to each other. As will be understood by those of ordinary skill in the art, the patent portfolio can be used to identify targets for purchase (e.g. targets for acquisitions, mergers, and other purchases) and for other business purposes.

In one embodiment, the disclosed systems and methods can be used to identify assignees to which an inventor assigns his publications over time. Based on the identified assignees, a career path of the inventor can be determined. As will be understood by those of ordinary skill in the art, the career path can be used for hiring purposes.

In one embodiment, the disclosed systems and methods can be used to identify competitors and/or inventors in selected technology areas (e.g. volatile technology areas) based on references included in publications associated with the competitors and/or the inventors. As will be understood by those of ordinary skill in the art, this information can be used to identify targets for purchase and for other business purposes.

In one embodiment, the disclosed systems and methods can be used to monitor one or more patent publications (including a patent portfolio) in time. For example, a selected issued patent associated with a patent application filing date can be monitored to identify references to the issued patent in patent publications and non-patent publications associated with filing dates later than the filing date of the issued patent and/or publication dates later than the filing date of the issued patent. Also for example, a pending patent application can be monitored to identify patent publications that cite one or more of the publications cited by the pending patent application. These co-citing patent publications can include subject matter related to the pending patent application and can be relevant to determining a patent prosecution strategy. As previously described herein with respect to candidates for invalidating prior art, the degree of relevance can be proportional to the number of common citations between the starting patent publication and the co-citing patent publication. Based on identifying a co-citing patent publication, a patent applicant can determine whether to file one or more claims in a pending application (e.g. claims that can traverse and/or block the co-citing patent publication), file one or more continuing applications of a parent application (e.g. continuations, divisionals, continuations-in-part, non-provisionals, and reissues), declare one or more interferences with the co-citing patent publication, and disclose the co-citing publication to a patent-granting office, as these terms are understood by those of ordinary skill in the art of prevailing patent law (e.g. U.S., or other jurisdictional, patent law).

The systems and methods described herein are not limited to a hardware or software configuration; they can find applicability in many computing or processing environments. The systems and methods can be implemented in hardware or software, or in a combination of hardware and software. The systems and methods can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted. The computer programs can be stored on a storage medium or a device (e.g., compact disk (CD), digital video disk (DVD), magnetic disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein.

While the systems and methods described herein have been shown and described with reference to the shown embodiments, those of ordinary skill in the art will recognize or be able to ascertain many equivalents to the embodiments described herein by using no more than routine experimentation. Such equivalents are intended to be encompassed by the scope of the present disclosure and the appended claims.

For example, the systems and methods described herein can be used in accounting, business, engineering, entertainment, legal, and/or scientific settings to search databases and display retrieved data.

Accordingly, the appended claims are not to be limited to the embodiments described herein, can comprise practices other than those described, and are to be interpreted as broadly as allowed under prevailing law.

1. A method of searching a database of data elements, the method comprising:
based on a starting data element, identifying a first set of one or more data elements in the database, the data elements of the first set being referenced by the starting data element,
based on the first set, identifying a second set of one or more data elements in the database, the data elements of the second set referencing one or more of the data elements of the first set, and
generating data based on the data elements of the first and second sets and the relationships therebetween.

2. The method of claim 1, wherein identifying a first set of one or more data elements includes:
determining whether the starting data element includes one or more references to one or more other data elements, and
identifying a first set of one or more data elements based on the references.

3. The method of claim 1, wherein identifying a second set of one or more data elements includes:
determining whether one or more data elements in the database include one or more references to one or more of the data elements of the first set, and
identifying a second set of one or more data elements based on the references.

4. The method of claim 1, wherein the starting data element is associated with a starting time and wherein identifying a first set of one or more data elements includes identifying data elements referenced by the starting data element and associated with first times earlier than the starting time.

5. The method of claim 4, wherein identifying the second set of one or more data elements includes identifying data elements that reference the data elements of the first set and that are associated with second times later than the first times.

6. The method of claim 4, wherein identifying the second set of one or more data elements includes identifying data elements that reference the data elements of the first set and that are associated with second times later than the first times and earlier than the starting time.

7. The method of claim 1, further comprising:
providing the generated data to one or more of a user and a display.

8. The method of claim 1, further comprising:
graphically displaying the data elements of the first and second sets and the relationships therebetween.

9. The method of claim 8, wherein the data elements are represented by geometric shapes and wherein the relationships are represented by lines between geometric shapes.

10. The method of claim 9, further comprising:
determining locations at which to display the geometric shapes and the lines to reduce overlaps between geometric shapes and crossings between lines.

11. A method of searching a database to identify prior art publications for a starting patent publication, the method comprising:
based on the starting patent publication, identifying a first set of one or more publications in the database, the publications of the first set being cited by the starting patent publication,
based on the first set, identifying a second set of one or more publications in the database, the publications of the second set citing one or more of the publications of the first set, and
generating data based on the publications of the first and second sets and the citation relationships therebetween.

12. The method of claim 11, wherein the publications include one or more of patent publications and non-patent publications.

13. The method of claim 12, wherein the patent publications include one or more of issued patents, published patent applications, and non-published patent applications.

14. The method of claim 11, further comprising:
providing the generated data to one or more of a user and a display.

15. The method of claim 11, further comprising:
graphically displaying the publications of the first and second sets and the relationships therebetween.

16. The method of claim 11, wherein the publications are represented by geometric shapes and wherein the relationships are represented by lines between geometric shapes.

17. The method of claim 11, further comprising:
determining locations at which to display the geometric shapes and the lines to reduce overlaps between geometric shapes and crossings between lines.

18. The method of claim 11, further comprising:
based on the second set, identifying one or more candidate patent publications for one or more of: invalidating prior art for the starting patent publication, licensing opportunities, and seminal prior art.

19. The method of claim 18, wherein identifying one or more candidate patent publications for invalidating prior art includes:
identifying one or more patent publications in the second set that do not cite the starting patent publication, that are not cited by the starting patent publication, and that are associated with filing dates earlier than the starting patent publication.

20. The method of claim 18, wherein identifying one or more candidate patent publications for licensing opportunities includes:
identifying one or more patent publications that are associated with a first assignee and that are cited by one or more patent publications associated with one or more different second assignees.

21. The method of claim 18, wherein identifying one or more candidate patent publications for seminal prior art includes:
identifying one or more patent publications that cite a first number of patent publications and that are cited by a second number of patent publications, wherein the second number is greater than the first number.

22. The method of claim 11, further comprising:
based on the second set, identifying one or more co-citing patent publications, the co-citing patent publications including patent publications of the second set that are associated with one or more of: filing dates later than the filing date of the starting patent publication and publication dates later than the filing date of the starting patent publication.

23. The method of claim 22, further comprising:
based on the co-citing patent publications, determining a patent prosecution strategy including one or more of:
filing one or more claims in a pending application,
filing one or more continuing applications of a parent application,
declaring one or more interferences, and
disclosing one or more of the co-citing patent publications to a patent-granting office.

24. A processor program for searching a database to identify prior art publications for a starting patent publication, the processor program being stored on a processor readable medium and comprising instructions to cause a processor to:
based on the starting patent publication, identify a first set of one or more publications in the database, the publications of the first set being cited by the starting patent publication,
based on the first set, identify a second set of one or more publications in the database, the publications of the second set citing one or more of the publications of the first set, and
generate data based on the publications of the first and second sets and the citation relationships therebetween.

25. The processor program of claim 24, further comprising instructions to:
based on the second set, identify one or more candidate publications for invalidating prior art for the starting patent publication, the candidate publications including publications in the second set that do not cite the starting patent publication, that are not cited by the starting patent publication, that cite one or more publications cited by the starting patent publication, and that are associated with filing dates earlier than the starting patent publication.

26. The processor program of claim 24, further comprising instructions to:
based on the second set, identify one or more candidate patent publications for licensing opportunities, the candidate patent publications for licensing opportunities including one or more patent publications that are associated with a first assignee and that are cited by one or more patent publications associated with one or more different second assignees.

27. The processor program of claim 24, further comprising instructions to:
based on the second set, identify one or more candidate patent publications for seminal prior art, the candidate patent publications for seminal prior art including one or more patent publications that cite a first number of patent publications and that are cited by a second number of patent publications, wherein the second number is greater than the first number

28. The processor program of claim 24, further comprising instructions to:
based on the second set, identify one or more co-citing patent publications, the co-citing patent publications including patent publications of the second set that are associated with one or more of: filing dates later than the filing date of the starting patent publication and publication dates later than the filing date of the starting patent publication.
